(19) United States
(12) Patent Application Publication
(10) Pub. No.: US 2024/0262234 A1
(43) Pub. Date: Aug. 8, 2024

(54) CHARGING AND DISCHARGING OF ELECTRIC VEHICLE (EV) CHARGING STATION BATTERIES

(71) Applicant: FREEWIRE TECHNOLOGIES, INC., Newark, CA (US)

(72) Inventors: Yu Hei Sunny Wai, Belmont, CA (US); Shawn Sullivan, Cupertino, CA (US)

(21) Appl. No.: 18/195,194

(22) Filed: May 9, 2023

Related U.S. Application Data
(60) Provisional application No. 63/443,763, filed on Feb. 7, 2023.

(51) Int. Cl. B60L 53/62; B60L 53/53; H02J 7/00

(52) U.S. Cl. CPC B60L 53/62; B60L 53/53; H02J 7/0048; H02J 7/00712

(57) ABSTRACT

The following relates generally to charging and discharging electric vehicle (EV) charging station batteries. In some embodiments, a first battery stack is charged by: (i) providing electrical power from a second battery stack to a switch mode power supply, and (ii) providing electrical power from the switch mode power supply to the first battery stack. A controller may then determine an occurrence of a trigger event associated with a first state of charge (SOC) of the first battery stack or a second SOC of the second battery stack. In response to determining the trigger event occurrence, the second battery stack may be charged by: (i) providing electrical power from the first battery stack to the switch mode power supply, and (ii) providing electrical power from the switch mode power supply to the second battery stack.

### CROSS REFERENCE TO RELATED APPLICATIONS

This application claims the benefit of U.S. Provisional Application No. 63/443,763, entitled “Charging and Discharging of Electric Vehicle (EV) Charging Station Batteries” filed Feb. 7, 2023, the entirety of which is incorporated by reference herein.

### TECHNICAL FIELD

At least one aspect of this application generally relates to improvements to preparation of batteries for vehicle charging stations generally and more particularly to improvements in the efficiency of initial charging and discharging cycles.

### BACKGROUND

To ensure optimal performance throughout the life of an electric vehicle (EV) charging station battery, it is important that the EV charging station battery be fully charged and discharged during its first two to three charge-discharge cycles. Thus, EV charging station batteries are sometimes fully charged and discharged for several cycles prior to installation in EV charging stations. Such initial charging and discharging cycles are also useful in establishing a charging profile or charging characteristics of a particular battery, which may then be used during operation of the EV charging station.

However, current systems for accomplishing this are inefficient and cumbersome. For example, some systems charge the EV charging station batteries, and then discharge them by connecting them to a device that depletes them by dissipating the electrical energy away as heat. This effectively results in a total waste of electrical energy. In addition, the equipment required to charge the EV charging station batteries (e.g., a specialized transformer, etc.) is both immobile and expensive, thus even further making current systems both cumbersome and undesirable. The systems and methods disclosed herein provide solutions to these problems and others.

### SUMMARY

Embodiments disclosed herein provide systems, methods, and apparatuses that charge and discharge EV charging station batteries. As described further herein, a method for charging and discharging electric vehicle (EV) charging station batteries may be provided. The method may comprise: charging a first battery stack by: (i) providing electrical power from a second battery stack to a switch mode power supply, and (ii) providing electrical power from the switch mode power supply to the first battery stack; determining, by a controller, occurrence of a trigger event associated with a first state of charge (SOC) of the first battery stack or a second SOC of the second battery stack; and in response to determining occurrence of the trigger event, charging the second battery stack by: (i) providing electrical power from the first battery stack to the switch mode power supply, and (ii) providing electrical power from the switch mode power supply to the second battery stack.

In some embodiments, the method further comprises receiving, at the controller from a first battery management system (BMS) electrically coupled to the first battery stack, a first battery stack charge status signal, wherein the first BMS is configured to generate the first battery stack charge status signal indicating the first SOC of the first battery stack.

In some embodiments, the trigger event comprises the first SOC exceeding a battery stack charge completion threshold of at least approximately 85% SOC.

In some embodiments, the method further comprises receiving, at the controller from a second BMS electrically coupled to the second battery stack, a second battery stack charge status signal, wherein the second BMS is configured to generate the second battery stack charge status signal indicating the second SOC of the second battery stack.

In some embodiments, the trigger event comprises the second SOC not exceeding a battery stack charge depletion threshold of less than approximately 10% SOC.

In some embodiments, the switch mode power supply comprises: a boost component configured to: (i) receive an input voltage from either the first battery stack or the second battery stack, and (ii) output a boosted output voltage to a buck component; and the buck component configured to: (i) receive the boosted output voltage, and (ii) output a charging current to either of the first battery stack or the second battery stack. In some such embodiments: the boosted output voltage is approximately 860V; and the received input voltage is between approximately 600V and 810V.

In some embodiments, the charging current is determined based on a charging current signal generated by: (i) a first BMS electrically coupled to the first battery stack, or (ii) a second BMS electrically coupled to the second battery stack.

In some embodiments, the method further comprises: determining, by the controller, occurrence of a top off power supply trigger event associated with the first SOC of the first battery stack or the second SOC of the second battery stack; and in response to determining occurrence of the top off power supply trigger event, providing, from a top off power supply, additional electrical power to the second battery stack.

In some embodiments, determining the top off power supply trigger event comprises determining that: (i) the first SOC of the first battery stack has fallen below a battery stack charge depletion threshold, and (ii) the second SOC of the second battery stack has not passed a battery stack charge completion threshold.

In another aspect, a non-transitory computer-readable storage medium for charging and discharging electric vehicle (EV) charging station batteries may be provided. The non-transitory computer-readable storage medium may comprise instructions that, when executed by one or more processors of a controller of a system, cause the controller to control the system to: charge a first battery stack by: (i) providing electrical power from a second battery stack to a switch mode power supply, and (ii) providing electrical power from the switch mode power supply to the first battery stack; determine occurrence of a trigger event associated with a first SOC of the first battery stack or a second SOC of the second battery stack; and in response to the determination of occurrence of the trigger event, charge the second battery stack by: (i) providing electrical power from the first battery stack to the second battery stack, and (ii) providing electrical power from the switch mode power supply to the second battery stack.

In yet another aspect, a system for charging and discharging electric vehicle (EV) charging station batteries may be provided. The system may comprise: a first battery assembly comprising: (i) a first battery stack, and (ii) a first BMS, wherein the first BMS is configured to generate a first battery stack charge status signal indicating a first SOC of the first battery stack; a second battery assembly comprising: (i) a second battery stack, and (ii) a second BMS, wherein the second BMS is configured to generate a second battery stack charge status signal indicating a second SOC of the second battery stack; a switch mode power supply electrically connected to the first battery assembly and the second battery assembly; and a controller communicatively connected to the first BMS, the second BMS, and the switch mode power supply and configured to: control charging of the first battery stack until occurrence of a trigger event by: (i) providing electrical power from the second battery stack to the switch mode power supply and (ii) providing electrical power from the switch mode power supply to the first battery stack; determine occurrence of the trigger event based upon the first SOC or the second SOC; and in response to determining occurrence of the trigger event, control charging of the second battery stack by: (i) providing electrical power from the first battery stack to the switch mode power supply and (ii) providing electrical power from the switch mode power supply to the second battery stack.

This summary is not comprehensive and is necessarily limited to certain aspects of the invention described herein. Additional or alternative components, aspects, functions, or actions may be included in various embodiments, as described further below.

### BRIEF DESCRIPTION OF THE DRAWINGS

FIG. 1 illustrates an example of an electric vehicle charging system configured in accordance with certain aspects disclosed herein.

FIG. 2 illustrates an example of an energy storage module configured in accordance with certain aspects of this disclosure.

FIG. 3 shows an example system for charging and discharging EV charging station batteries and/or EV batteries.

FIG. 4 is a flowchart of an example method for charging and discharging EV charging station batteries and/or EV batteries.

FIG. 5 is a flowchart of a method for charging and discharging EV charging station batteries and/or EV batteries, including monitoring alarms, and ending at SOC 50%.

FIG. 6A illustrates an example system including four battery assemblies during a first cycle.

FIG. 6B illustrates an example system including four battery assemblies during a second cycle.

FIG. 7 illustrates an example system including four battery assemblies, and bypasses.

FIG. 8 illustrates a flowchart of a method for charging and discharging EV charging station batteries and/or EV batteries, including charging two groups of EV charging station batteries.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of electric vehicle (EV) or plug-in hybrid vehicle charging systems will now be presented with reference to various apparatuses and methods. These apparatuses and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include read-only memory (ROM) or random-access memory (RAM), electrically erasable programmable ROM (EEPROM), including ROM implemented using a compact disc (CD) or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), and floppy disk where disks usually reproduce data magnetically, while discs reproduce data optically with lasers. Combinations of the above should also be included within the scope of computer-readable media.

Batteries for EV charging stations are designed to store large amounts of energy for long durations and are intended to operate efficiently for years. Degradation of EV charging station battery performance reduces the availability of the corresponding EV charging station and results in waste, as the battery will need to be replaced in order to ensure operating parameters of the EV charging station continue to be met. For EV charging station batteries, the first two to three charge-discharge cycles are particularly important. More specifically, full charging and discharging during these initial cycles ensures optimal performance throughout the life of an EV charging station battery. Thus, EV charging station batteries are sometimes fully charged and discharged for several cycles prior to installation in an EV charging station. Additionally, the charging parameters or profile of the batteries may be determined based upon the initial charging and discharging cycles, as such cycles are typically performed under controlled conditions and closely monitored.

Yet, current systems for accomplishing this are inefficient and cumbersome. For example, some systems charge the EV charging station batteries, and then discharge them through heating elements that dissipate the electrical energy away as heat. This effectively results in a total waste of electrical energy, and further energy may be required to remove excess heat from the local environment. In addition, the equipment required to charge the EV charging station batteries (e.g., a specialized transformer, etc.) is both immobile and expensive, thus even further making current systems both cumbersome and undesirable.

Certain aspects of this disclosure provide improved techniques for charging and discharging EV charging station batteries. In one working example, the techniques described herein may connect first and second EV charging station battery stacks through a switch mode power supply. The first battery stack may then be charged by discharging electrical energy from the second battery stack into the first battery stack through the switch mode power supply. The switch mode power supply may control the voltage output to the first battery stack, as well as control a charging current output to the first battery stack. Once the first battery stack is sufficiently charged, the process may reverse and the first battery stack may be discharged into the second battery stack (e.g., through the switch mode power supply) to thereby recharge the second battery stack. The switch mode power supply may control the voltage output to the second battery stack, as well as control a charging current output to the second battery stack. The process may repeat until a desired number of cycles is reached.

### Example EV Charging Systems

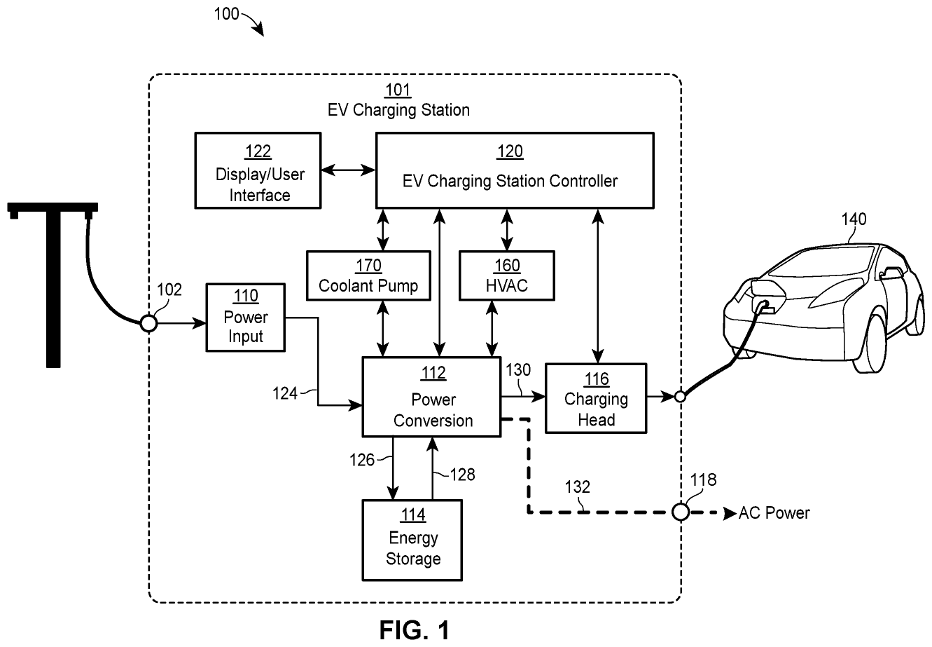

Broadly speaking, FIG. 1 illustrates an example EV charging system 100 that includes a battery stack for storing energy used in charging EVs. The illustrated EV charging system 100 may include EV charging station 101, and may be provided in a residence, commercial property or publicly-accessible parking facility. The EV charging system 100 includes a power input module 110 that includes one or more circuits configurable to transform, condition or otherwise modify alternating current (AC) power received from an input port 102, to provide conditioned power 124 to a power conversion module 112. The power conversion module 112 includes an AC-to-DC conversion circuit that generates a DC charging current 126 that is provided to an energy storage module 114. In various embodiments, the power input module 110 and the power conversion module 112 may be combined, or their functions may be differently configured (e.g., by converting the input AC power to DC power at the power input module 110). In one example, the energy storage module 114 includes high-capacity batteries that have a storage capacity greater than a multiple of the storage capacity in the EVs to be charged (e.g., three times, five times, or ten times a specific or average EV battery capacity).

In a residential implementation where N EVs are expected to receive a daily charge of P kW on a regular basis, the energy storage module 114 may have a storage capacity of at least (N+1)×P kW in order to accommodate the expected daily demand. In some instances, P may be set to the maximum charge capacity of each of the EVs. In other instances, the storage capacity of the energy storage module 114 may be configured based on expected usage of the EVs and resultant daily depletion in charge.

In an EV charging system 100 provided for commercial or public use, the storage capacity of the energy storage module 114 may be configured based on the maximum number of expected charging events in a day. The maximum number of expected charging events in a day may be calculated based on times of day in which the EV charging system 100 is made accessible. The storage capacity of the energy storage module 114 may further be configured based on the expected average charge per charging event, which may depend upon factors such as the types of EVs charged, the depletion level of the EV batteries when charging starts, and the duration of each charging event. For example, a retail parking site may have more charging events of shorter duration, while a commuter train parking lot may have fewer charging events of longer duration.

In various examples, the storage capacity of the energy storage module 114 may be configured based on maximum expected charging offset by power received from an electric utility. In some of these examples, the power received from an electric utility may be limited to power available during low-demand times, such as off-peak or low-priced periods of the day. The power input module 110 may be configured to block or disconnect inflows of power during peak or high-priced periods of the day. In some instances, the power input module 110 may be configured to enable power reception during peak periods to ensure continued operation of the EV charging system 100 when power levels in the energy storage module 114 are unexpectedly low.

According to certain aspects of this disclosure, the power conversion module 112 may include one or more DC-to-DC conversion circuits that receive DC current 128 at a first voltage level from the energy storage module 114 and drive a charging current 130 to an EV 140 through a charging head 116. The EV charging system 100 may be coupled to multiple charging heads 116 and the power conversion module 112 may include a corresponding number of DC-to-DC conversion circuits. In some instances, the charging head 116 may include power control circuits that further modify or control the voltage level of the charging current 130 passed through to the EV 140.

In some examples, the power conversion module 112 includes one or more inverters that convert the DC current 128 to an AC current 132 that can be provided at an AC output 118 of the EV charging system 100. The AC output 118 may be used to power one or more external charging heads or may be provided as backup power source for more general use. For example, the AC output 118 may comprise an outlet into which AC devices may be plugged or a direct connection to one or more devices or circuits in order to provide backup power at the site of the EV charging system 100.

According to certain aspects of this disclosure, an EV charging station controller 120 may be configured to control operations of the power conversion module 112. The EV charging station controller 120 may monitor and control power levels received by the power input module 110, power levels output through the charging current 130 and/or the AC current 132 and energy levels in the energy storage module 114. The EV charging station controller 120 may monitor temperatures within the EV charging system 100 and/or within different components of the EV charging system 100 and may be configured to mitigate increases in temperature through active cooling (e.g., using one or more HVAC components 160 or coolant pumps 170) or power reductions (e.g., by reducing currents 126, 128, or 130).

The EV charging station controller 120 may be configured to communicate with the components of the EV charging system 100, including power conversion, inverter and power conditioning circuits over one or more data communication links. The EV charging station controller 120 may be configured to communicate with controllers or sensors coupled to the energy storage module 114, the charging head 116 and external devices, including an EV being charged. The EV charging station controller 120 may manage, implement or support one or more data communication protocols used to control communication over the various communication links. The data communication protocols may be defined by industry standards bodies or may be proprietary protocols.

In some examples, the power conversion module 112 includes some combination of AC-to-DC, DC-to-DC and/or DC-to-AC converters that enables efficient conversion of AC input power received from a power utility to a DC charging current 126 provided to the energy storage module 114 and from the energy storage module 114 to EV 140. In one example, an inverter may be configured to achieve greater efficiency and cost effectiveness while enabling at least 150 kW charging levels, in contrast to the 120 kW levels provided by other systems. In some instances, the EV charging system 100 can provide an output current at or above 1000 volts that can match higher battery voltages used in some EVs 140. The higher voltage levels can enable faster, more efficient charging.

The EV charging station 101 may also include a user interface module 122 that can receive tactile or spoken input and can display information related to the operation of the EV charging system 100. The user interface module 122 may include or be coupled to a display with capabilities that reflect intended use of the EV charging system 100. In one example, a large nineteen-inch touchscreen may be provided to present details of charging status and user instructions, including instructions describing the method of connecting an EV 140. In another example, a small (four to six inch) LCD panel and display may be provided by the EV charging system 100. The user interface module 122 may include or be coupled to a touchscreen that interacts with the EV charging station controller 120 to provide additional information or advertising. The EV charging station controller 120 may include or be coupled to a wireless communication interface that can be used to deliver a wide variety of content to users of the EV charging system 100, including advertisements, news, point-of-sale content for products/services that can be purchased through the user interface module 122. The display system may be customized to match commercial branding of the operator, to accommodate language options and for other purposes.

Through the user interface module 122, the EV charging station controller 120 may provide information to enable the user to start charging, to confirm the start of charging, and to track the status of charging and so on. The user interface module 122 may support various input devices, including identity cards, touchless credit cards and other devices that interact through near-field communication protocols. The user interface module 122 may support user authentication protocols and may include or be coupled to biometric input devices such as fingerprint scanners, iris scanners, facial recognition systems and the like.

In one aspect of this disclosure, the energy storage module 114 is provisioned with a large battery stack and the EV charging station controller 120 is controlled by software that is configured to manage input received from an electrical power grid to the battery stack such that power is drawn from the grid to charge the battery stack at low-cost time periods and to avoid drawing power from the grid during peak-cost hours. The software may be further configured to manage power output to provide full, fast charging power in accordance with usage generated by monitoring patterns of usage by the EV charging system 100. The use of historical information can avoid situations in which the battery stack becomes fully discharged or depleted beyond a minimum energy threshold. For example, charging may be limited at a first time based upon a predicted later demand at a second time, which later demand may be predicted using historical information. This may spread limited charging capacity more evenly among vehicles throughout the course of a day or in other situations in which battery stack capacity is expected to be insufficient to fully charge all EVs over a time interval, taking account of the ability to add charge to the energy storage module 114.

In some examples, the energy storage module 114 may include additional air cooling for the battery stack and/or liquid cooling for the space surrounding the battery stack. Thermal blankets may also be used for warming batteries in cold conditions, and metal plates can be added to act as buffers and/or as additional heat sinks for cooling. In some examples, the liquid cooling may be provided by the coolant pump 170, which may be controlled by the EV charging station controller 120.

In one example, the energy storage module 114 is provisioned with a battery stack that can deliver 160 kWh, which can charge a series of EVs 140 without significant delays between EVs 140 and without the energy storage module 114 falling below 50% capacity. The battery stack may be fully recharged during the lowest-cost periods of the day when local grid demand is lowest, which may correspond to late night or early morning hours. The EV charging system 100 may draw power from the electric grid at normal residential levels (e.g., <30 kW) and may be used at virtually all existing premises without utility upgrades, construction costs and associated delays in approvals, permits, construction projects for such upgrades.

In certain examples, one or more EV charging systems 100 may be prefabricated and preconfigured, such that they can be installed within a few hours of delivery. Each EV charging system 100 occupies a small footprint and can be connected directly to an existing utility service access point provided on the premises. Installation of these EV charging systems 100 may be accomplished after providing conduit as needed from electrical service access points, and bolting the EV charging systems 100 to the ground or to a wall. The EV charging systems 100 can charge EVs 140 within hours of installation. In one example, an EV charging system 100 is enclosed in single metal housing that integrates batteries, inverters, power conversion circuits, wiring harnesses and control systems including the EV charging station controller 120 and other components of a battery management system (BMS).

Although the example system 100 shows only one charging head 116, two or more charging heads 116 may be provided to enable concurrent charging of multiple EVs 140. The EV charging station controller 120 may be configured by a user to support multiple modes of operation and may define procedures for power distribution that preserve energy levels in the energy storage module 114 when multiple EVs 140 are being concurrently charged. Distribution of power may be configured to enable fast charging of one or more EVs 140 at the expense of other EVs 140. In this regard, the charging ports may be prioritized or the EV charging station controller 120 may be capable of identifying and prioritizing connected EVs 140. In some instances, a user may identify priorities dynamically through the user interface module 122. For example, the EV charging station controller 120 may be configured to continue charging a first EV 140 at a maximum 120 kW when a second EV 140 is connected to a charging port, and may refrain from charging the second EV 140 until the charging rate for the first EV 140 drops below 60 kW. Reductions in charging rate may be configured to prevent thermal issues as the EV 140 approaches full charge. In this example, a 120 kW available power level may be split according to priorities.

In other examples, the EV charging station controller 120 may be configured to automatically split available power between two EVs 140 after the second EV 140 is connected. The available power may be evenly split between two EVs 140 or may be split according to priorities or capabilities. In some examples, the EV charging station controller 120 may conduct arbitration or negotiation between connected EVs to determine a split of charging capacity. An EV 140 may request a charging power level at any given moment based on temperature, battery charge level, and other characteristics of the EV 140 and its environment and to achieve maximum charge rate and minimum charging time for the current circumstances.

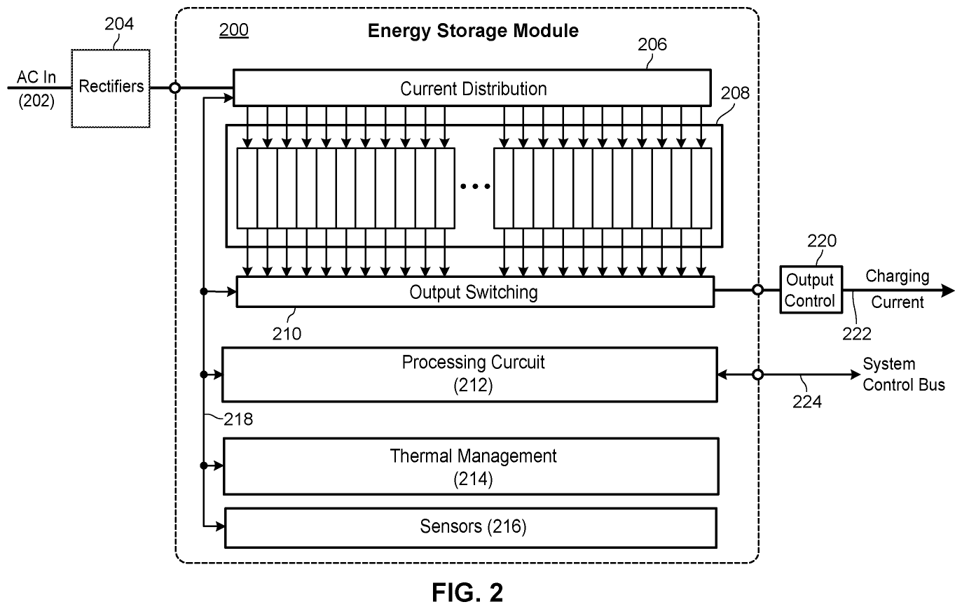

FIG. 2 illustrates an example of an energy storage module 200 configured in accordance with certain aspects of this disclosure. The energy storage module 200 may correspond to the energy storage module 114 illustrated in FIG. 1, for example. The energy storage module 200 may receive DC power derived from an AC input 202. The AC input 202 may be converted to DC by one or more power conversion circuits. Power conversion circuits may include one or more circuits configurable to transform, condition or otherwise modify the AC input 202 to provide a conditioned DC power output. For example, a generalized power conversion module includes an AC-to-DC conversion circuit that generates a DC charging current. In the illustrated example, the power conversion circuits are represented as a block of rectifiers 204. Multiple power conversion circuits may be provided, with each power conversion circuit being individually controlled to provide a charging current to one or more batteries in a battery stack 208. The power conversion circuits may be controlled or configured to optimize the charging process for each battery or group of batteries in the charging battery stack 208.

The battery stack 208 may be configurable to select groups of batteries to provide charging currents to corresponding EVs during EV charging operations. Each group of batteries may be associated with a conversion circuit. In some instances, a best available conversion circuit may be dynamically selected to charge a group of batteries. Dynamic selection may match available conversion circuits to groups of batteries based on current demand by the group of batteries, current delivery capabilities of the conversion circuits, temperature and other operating conditions of the conversion circuits, and/or for other reasons. A current distribution module 206 may include switching circuits that can couple the outputs of groups of batteries to designated conversion circuits.

The outputs of the batteries in the battery stack 208 may be provided to an output switching circuit 210 that is configured to couple one or more batteries or groups of batteries to provide a charging current 222. The number of batteries or groups of batteries used to provide the charging current 222 may be selected based on capacity of the batteries, current output levels of the batteries and current levels requested by the EV that is being charged. An output control circuit 220 may be provided to deliver output power at a consistent voltage and wattage. The output control circuit 220 may include DC-to-DC converters such as buck and boost circuits that change voltage level of the battery output, filters to remove transients and sensors that can be used to increase or decrease the number of batteries used to produce the charging current 222.

The current distribution module 206, output switching circuit 210, the output control circuit 220 and a thermal management module 214 may respond to commands and control signals provided by a processing circuit 212 that is configured to manage operation of the energy storage module 200. To effect such control and to receive operating data regarding the energy storage module 200, the processing circuit 212 may be communicatively connected to the current distribution module 206, the output switching circuit 210, the thermal management module 214, and sensors 216 by an internal bus 218. The processing circuit 212 may cooperate with external processors to determine and activate configurations of batteries to use for charging an EV, and the processing circuit 212 may be communicatively connected to such external processors via a system control bus 224. In one example, the processing circuit 212 is configured as a finite state machine. In some examples, the processing circuit 212 includes a programmable logic controller (PLC), microcontroller, microprocessor or other type of processor.

The processing circuit 212 may be configured to limit input current flow based on the capacity of a provisioned utility service that provides the AC input 202. In one example, the processing circuit 212 may limit input current to remain within a 30 kW ceiling for a circuit provided by a power utility company. The processing circuit 212 may be further configured to manage power flows when, for example, an EV is drawing 120 kW or more and while the AC input 202 is supplying 30 kW or less. Power flows may be managed by configuring groups of batteries used to provide a desired or requested charging current 222 and switching between groups of batteries when depletion is imminent or when the requested level of the charging current 222 changes.

The thermal management module 214 may include, control, configure or manage the operation of cooling and heating elements, such as HVAC components 160 or coolant pumps 170, which are used to maintain temperatures within minimum and maximum limits defined for the batteries and associated circuits. The heating and cooling elements may include forced air components such as fans or impellers, a coolant supply that is circulated through channels, pipes or ducts within the energy storage module 200, compressors and other components of thermodynamic systems that provide a Carnot cycle, heat pumps, heat exchangers radiant heaters, induction heaters, burners and so on. Cooling may be activated due to environmental conditions or when heat generation by the components of the energy storage module 200 increase internal temperatures. Cooling may be activated due to environmental conditions when external temperatures drop to levels that preclude battery or ancillary circuit operation.

The thermal management module 214 may include or be connected to sensors 216. Certain sensors 216 may be configured to monitor operating conditions within and without the thermal management module 214. Certain sensors 216 may be configured to monitor current flows, battery capacity and/or stored energy levels. The output of the sensors 216 may be monitored by or through the processing circuit 212. In some instances, sensor data may be directly monitored by external processors. In some instances, certain sensors 216 may trigger an event or alarm that causes the processing circuit 212 to immediately terminate operations of the energy storage module 200. In one example, an emergency shutdown may be indicated by an over-temperature, over-current or over-voltage condition. In another example, an emergency shutdown may be executed in response to a command or signal received from an external source such as a facilities management system via a system control bus 224.

### Example Battery Charging and Discharging Systems

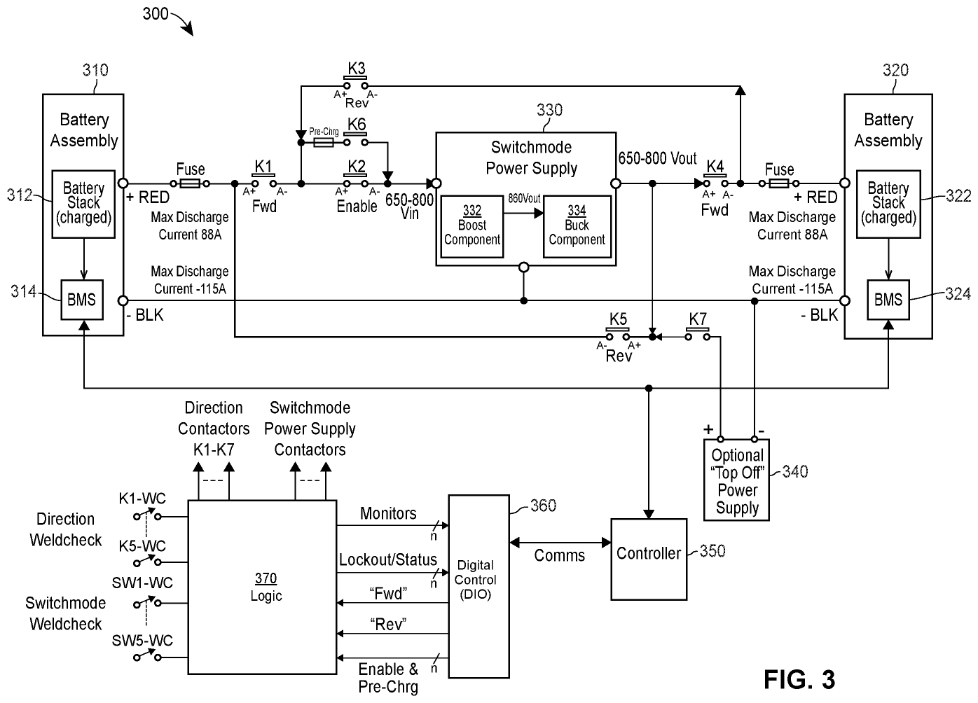

As mentioned above, the first two to three charge-discharge cycles for EV charging station batteries, such as the battery pack 208, are particularly important. More specifically, full charging and discharging during these initial cycles ensures optimal performance throughout the life of an EV charging station battery. To this end, FIG. 3 shows an example system 300 for charging and discharging EV charging station batteries and/or EV batteries.

The illustrated example system 300 includes a first battery assembly 310, which includes a battery stack 312. The first battery stack 312 may correspond to the battery stack 208 illustrated in FIG. 2 and/or batteries of the energy storage module 114 illustrated in FIG. 1. As mentioned above, one purpose of the system 300 is to sufficiently charge and discharge the battery stack 312 during its first two to three initial cycles to thereby improve battery life and performance.

The battery assembly 310 further includes a battery management system (BMS) 314. The BMS 314 may monitor and/or record any characteristics or events of the battery stack 312. For example, the BMS 314 may monitor and/or record: a state of charge (SOC) of the battery stack 312, an input current of the battery stack 312, an input voltage of the battery stack 312, an output current of the battery stack 312, and/or an output voltage of the battery stack 312. Additionally or alternatively, the battery management system 314 may send signal(s) indicating a voltage and/or current level for charging the battery stack 312. Additionally or alternatively, in some embodiments, the BMS 314 may generate trigger signals relating to the SOC of the battery stack 312 and/or create a log of events for the battery stack 312 (e.g., starting and ending times of charging or discharging, measured voltage levels, or measured current levels).

The illustrated example system 300 further includes a second battery assembly 320, which includes a battery stack 322. The second battery stack 322 may (similarly to the first battery stack 312) correspond to the battery stack 208 illustrated in FIG. 2 and/or batteries of the energy storage module 114 illustrated in FIG. 1. As mentioned above, one purpose of the system 300 is to sufficiently charge and discharge the battery stack 322 during its first two to three initial cycles to thereby improve battery life and performance.

The battery assembly 320 further includes BMS 324. The BMS 324 may monitor and/or record any characteristics or events of the battery stack 322. For example, the BMS 324 may monitor and/or record: a SOC of the battery stack 322, an input current of the battery stack 322, an input voltage of the battery stack 322, an output current of the battery stack 322, and/or an output voltage of the battery stack 322. Additionally or alternatively, the battery management system 324 may send signal(s) indicating what voltage and/or current to charge the battery stack 322 with. Additionally or alternatively, in some embodiments, the BMS 324 may generate trigger signals relating to the SOC of the battery stack 322, and/or create a log of events for the battery stack 322 (e.g., starting and ending times of charging or discharging, measured voltage levels, or measured current levels).

The example system 300 may further include a switch mode power supply 330. In some examples, the switch mode power supply 330 receives an input voltage from the battery stack being discharged. In the example of FIG. 3, the battery stack 312 is being discharged, and thus the input voltage Vᵢₙ of the switch mode power supply 330 is received from the battery stack 312. In some examples, the voltage received from the discharging battery stack ranges from approximately 650V to 800V. For instance, initially, if the battery stack 312 starts from fully charged, it may provide a voltage of approximately 800V to the switch mode power supply 330; and, as the SOC of the battery stack 312 depletes, the input voltage Vᵢₙ is reduced to approximately 650V.

The switch mode power supply 330 may output an output voltage to the battery stack being charged, which, in the example of FIG. 3, is battery stack 322. The switch mode power supply 330 may allow the output voltage Vₒᵤₜ to vary (e.g., from 650V to 800) so that the charging current (e.g., the current output by the switch mode power supply 330 to the battery stack being charged) may vary to reach a particular level. For example, the BMS 324 may request a charging current level (e.g., 10 A, 15 A, 20 A, 88 A, etc.), and the switch mode power supply 330 may allow the output voltage to vary so that the charging current may reach the level requested by the BMS 324. However, it should be understood that this is just one example, and the charging current may be determined by other techniques as well.

The switch mode power supply 330 may be considered to include a boost component 332 and a buck component 334, which operate together to provide the desired output voltage Vₒᵤₜ. Thus, the boost component 332 may step up the input voltage Vᵢₙ supplied to the switch mode power supply 330, and the buck component 334 may step down the voltage to supply the output voltage Vₒᵤₜ from the switch mode power supply 330. For instance, in the example of FIG. 3, the boost component 332 converts the input voltage to a boosted voltage of 860V (or any other suitable voltage, such as any voltage between 750V and 950V), which is above the desired charging voltage for the battery stack 322. The buck component may then reduce the boosted voltage from 860V to 800V (or any other suitable voltage, such as any voltage between 700V and 900V) and output the 800V output voltage Vₒᵤₜ to the battery stack being charged. Thus, the buck component 334 may allow the output voltage to vary (e.g., from 650V to 800V) so that the charging current may vary to reach a particular level.

The example system 300 may further include a top off power supply 340. In some examples, the top off power supply 340 is used to replace power that is dissipated throughout the process of charging and recharging the battery stacks 312, 322 due to inherent losses in the various system components and connections. In one working example, for full charge, the battery stack 322 would need 160 kWh; however, once the battery stack 312 is depleted, the battery stack 322 has only reached 150 kWh, so the top off power supply 340 provides the remaining 10 kWh. In some embodiments, the top off power supply 340 provides a low current (e.g., less than 10 A) to the battery stack being charged because the battery being charged is close to being fully charged. In some embodiments, the top off power supply 340 includes a transformer to increase its voltage to, for example, 806V or more; for example, a fully charged battery stack may be 806V so the top off power supply 340 may go at least this high. In some embodiments, the top off power supply 340 provides a charging current to the battery stack 312 or the battery stack 322 requested, respectively, by the BMS 314, or BMS 324.

One or both of the BMS 314, 324 may provide signals to a controller 350, which may comprise one or more processors, and which may control contactors K1-K7 and/or other components throughout the system 300. For instance, the controller 350 may detect a first trigger signal from one or both of the BMS 314, 324; and, in response to the detection of the first trigger signal, the controller 350 may open or close contactors to cause one of the battery stacks 312, 322 to charge the other of the battery stacks 312, 322. For example, to charge the battery stack 322 from the battery stack 312, the controller 350 may close contactors K1, K2, and K4; and may open contactors K3, K5, K6 and K7. In another example, to charge the battery stack 312 from the battery stack 322, the controller 350 may close contactors K2, K3, K5; and may open contactors K1, K4, K6, K7.

Additionally, or alternatively, the controller 350 may detect a second trigger signal from one or both of the BMS 314, 324; and, in response to the detection, open or close contactors to charge either the battery stack 312 or the battery stack 322 from the top off power supply 340. For example, to charge the battery stack 322, the controller 350 may close contactors K4 and K7; and the controller 350 may open the remainder of the contactors. The first and second trigger signals will be discussed in further detail elsewhere herein.

To control the contactors, the controller 350 may be connected to a digital I/O controller 360, which may in turn control the contactors K1-K7 via logic circuit 370. In some embodiments, the digital I/O controller 360 outputs a forward (“Fwd”) signal to charge one of the battery stacks 312, 322; and outputs a reverse (“Rev”) signal to charge the other of the battery stacks 312, 322. The forward and reverse signals may be sent to the logic circuit 370, which may be used to control the contactors K1-K7, and/or switches within the switch mode power supply 330.

Furthermore, although FIG. 3 illustrates only two battery assemblies 310, 320, in accordance with the techniques described herein, any number of battery assemblies may be connected. For example, the system may transfer energy between any number of battery stacks, even though only two are shown in FIG. 3.

In some embodiments, the logic circuit 370 does not allow forward and reverse directions on at the same time. For example, the logic gates within the logic circuit 370 may not allow the forward and reverse directions to be on at the same time, even if it received both a forward and reverse signal from the digital I/O controller 360. Furthermore, the logic circuit 370 may set flags. For example, a flag may be set to indicate the direction of charging (e.g., indicating if the first battery stack 312 is to be charged or the second battery stack 322 is to be charged). In another example, a flag may be set indicating that a predetermined number of cycles has been reached (e.g., the first battery stack 312 has been charged and discharged twice, etc.).

### Example Methods

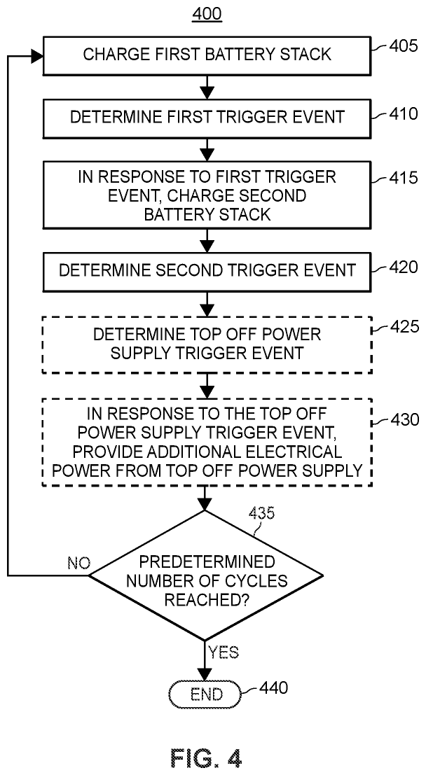

FIG. 4 is a flowchart of a method 400 for charging and discharging EV charging station batteries and/or EV batteries. To illustrate the principles discussed herein, the example method 400 begins with the first battery stack 312 initially discharged, and the second battery stack 322 initially charged. The second battery stack 322 may be initially charged by any known techniques using any power supply.

At block 405, the first battery stack 312 may be charged from the second battery stack 322 by: (i) providing electrical power from the second battery stack 322 to the switch mode power supply 330, and (ii) providing electrical power from the switch mode power supply 330 to the first battery stack 312. For example, the contactors K1-K7 may be controlled by the controller 350 to provide power in this way, as described above with respect to FIG. 3.

To further elaborate, in some embodiments, the boost component 332 of the switch mode power supply 330 receives an input voltage from the second battery stack 322, and then outputs a boosted output voltage to the buck component 334. In some examples, the voltage that the boost component 332 outputs to the buck component 334 is greater than the voltage than the buck component 334 will output to the battery stack 312, which facilitates the buck component 334 to allow the voltage that it outputs to the battery stack 312 to vary according to a desired charging current level. In some examples, the desired charging current level may be a current level requested by the BMS 314; for example, the BMS 314 may determine the desired current charging level (e.g., based on the SOC of the battery stack 312), and send the desired charging current level to the controller 350. In other examples, the BMS 314 may send the SOC of the battery stack 312 to the controller 350, and the controller 350 may determine the desired charging current level based on the SOC.

At block 410, a first trigger event is determined (e.g., by the controller 350) to have occurred during charging of the first battery stack 312. In some examples, the first trigger event may be an event associated with a first SOC of the first battery stack 312. For example, the first trigger event may comprise the first SOC exceeding a battery stack charge completion threshold (e.g., approximately 75%, 80%, 85%, 88%, 90%, 93%, 95%, 98%, etc.). For example, the BMS 314 may send a first battery stack charge status signal indicating the first SOC of the first battery stack 312 to the controller 350, and thus the controller 350 may determine the first trigger event. Alternatively, the BMS 314 may monitor the first SOC, and generate and send a first trigger event signal to the controller 350.

In other examples, the first trigger event is an event associated with a second SOC of the second battery stack 322. For example, the first trigger event may comprise the second SOC falling below a battery stack charge depletion threshold (e.g., approximately 20% SOC, 15% SOC, 10% SOC, 8% SOC, 5% SOC, 4% SOC, 2% SOC, etc.). For example, the BMS 324 may send a second battery stack charge status signal indicating the second SOC of the second battery stack 322 to the controller 350, and thus the controller 350 may determine the first trigger event. Alternatively, the BMS 324 may monitor the second SOC, and generate and send a first trigger event signal to the controller 350.

In still other examples, the first trigger event may be an event associated with both the first SOC and the second SOC. For example, the first trigger event may be determined when either the first SOC exceeds the battery stack charge completion threshold or the second SOC falls below a battery stack charge depletion threshold. In another example, the first trigger event may be determined when both the first SOC exceeds the battery stack charge completion threshold and the second SOC falls below a battery stack charge depletion threshold.

At block 415, in response to determining occurrence of the first trigger event, the second battery stack 322 is charged from the first battery stack 312 by: (i) providing electrical power from the first battery stack 312 to the switch mode power supply 330, and (ii) providing electrical power from the switch mode power supply 330 to the second battery stack 322. For example, the contactors K1-K7 may be controlled by the controller 350 to provide power in this way, as described above with respect to FIG. 3.

At block 420, a second trigger event is determined (e.g., by the controller 350) to have occurred during charging of the second battery stack 322. Such second trigger event may be similar to the first trigger event. In some examples, the second trigger event may be an event associated with a second SOC of the second battery stack 322. For example, the second trigger event may comprise the second SOC exceeding a battery stack charge completion threshold (e.g., approximately 75%, 80%, 85%, 88%, 90%, 93%, 95%, 98%, etc.). For example, the BMS 324 may send a second battery stack charge status signal indicating the second SOC of the second battery stack 322 to the controller 350, and thus the controller 350 may determine the second trigger event. Alternatively, the BMS 324 may monitor the second SOC, and generate and send a second trigger event signal to the controller 350.

In other examples, the second trigger event is an event associated with a first SOC of the first battery stack 312. For example, the second trigger event may comprise the first SOC falling below a battery stack charge depletion threshold (e.g., approximately 20% SOC, 15% SOC, 10% SOC, 8% SOC, 5% SOC, 4% SOC, 2% SOC, etc.). For example, the BMS 314 may send a first battery stack charge status signal indicating the first SOC of the first battery stack 312 to the controller 350, and thus the controller 350 may determine the second trigger event. Alternatively, the BMS 314 may monitor the first SOC, and generate and send a second trigger event signal to the controller 350.

In still other examples, the second trigger event may be an event associated with both the first SOC and the second SOC. For example, the second trigger event may be determined when either the second SOC exceeds the battery stack charge completion threshold or the first SOC falls below a battery stack charge depletion threshold. In another example, the second trigger event may be determined when both the second SOC exceeds the battery stack charge completion threshold and the first SOC falls below a battery stack charge depletion threshold.

At optional block 425, the controller determines if there is a top off power supply trigger event. In some embodiments, this is done in response to the determination of the second trigger event. For example, the second trigger event may indicate that the first SOC has fallen below a certain level, so that the first battery stack 312 is no longer able to effectively charge the second battery stack 322. In response to this determination, the controller may determine if there is also a top off power supply trigger event. If so, the system will supply power from the top off power supply 340 to the second battery stack 322. In some examples, the top off power supply trigger event comprises the second SOC being below a charge completion threshold (e.g., 75% SOC, 80% SOC, 83% SOC, 85% SOC, 88% SOC, 90% SOC, 93% SOC, 95% SOC, 98% SOC, etc.).

In some embodiments, the controller 350 determines the top off power supply trigger event by receiving SOC signals from one or both of the BMS 314 and the BMS 324. Additionally or alternatively, one or both of the BMS 314 and the BMS 324 may determine a top off power supply trigger signal and send it to the controller 350.

However, in some embodiments, the top off power supply trigger event and the second trigger event are combined into one determination. For instance, the top off power supply trigger event may be determined together with the second trigger event by determining that: (i) the first SOC of the first battery stack has fallen below a battery stack charge depletion threshold, and (ii) the second SOC of the second battery stack has not passed a battery stack charge completion threshold. Thus, in some embodiments, the second trigger event and the top off power supply trigger event do not need to be independently determined, and thus, in the example method 400, block 425 is illustrated as optional.

At optional block 430, if there has been a determination of the top off power supply trigger event (either separately or together with the determination of the second trigger event), the system provides electrical power from the top off power supply 340 to the second battery stack 322; for example, the controller 350 may close contactors K4 and K7. The top off power supply may then be used to continue charging the second battery stack 322 until the second battery stack 322 reaches a predetermined SOC threshold, which may be a threshold associated with the second trigger event, such as the second SOC exceeding a battery stack charge completion threshold (e.g., approximately 75%, 80%, 83%, 85%, 88%, 90%, 93%, 95%, 98%, etc.).

Additionally or alternatively, it should be understood that the optional blocks 425 and/or 430 may be performed at other points in the example method 400. For instance, the top off power supply 340 may supply power to the first battery stack 312. For example, optional blocks 425 and/or 430 may be performed along with, immediately preceding, or immediately following block 410. To supply power to the first battery stack 312, the controller 350 may close contactors K5 and K7. Similarly, optional blocks 425 and/or 430 may be performed along with, immediately preceding, or immediately following (as illustrated) block 420.

In any event, at block 435 it is determined (e.g., by the controller 350) if a predetermined number of cycles is reached. The predetermined number of cycles may be any number of cycles (e.g., 1 cycle, 2, cycles, 3 cycles, etc.). In some embodiments, a cycle is counted as a battery stack having been both fully charged (e.g., SOC greater than 75%; SOC greater than 80%; SOC greater than 85%; SOC greater than 88%; SOC greater than 90%; SOC greater than 93%; SOC greater than 95%; SOC greater than 98%; etc.) and fully discharged (e.g., SOC less than 2%; SOC less than 4%; SOC less than 5%; SOC less than 8%; SOC less than 10%; SOC less than 15%; SOC less than 20%; etc.). The determination may be made based on one of the battery stacks 312, 324 individually or both jointly (e.g., both battery stacks 312, 322 having been fully charged and discharged).

In some embodiments, the BMSs 314, 324 send SOC signals to the controller 350, and the controller 350 makes the determination if the predetermined number of completed cycles has been reached. In some embodiments, one or both of the BMSs 314, 324 log information regarding the cycles and send cycle complete signals to the controller 350.

If the predetermined number of cycles has not been reached, the example method 400 returns to block 405, and the first battery stack 312 is again charged. If the predetermined number of cycles has been reached, the example method 400 ends at block 440.

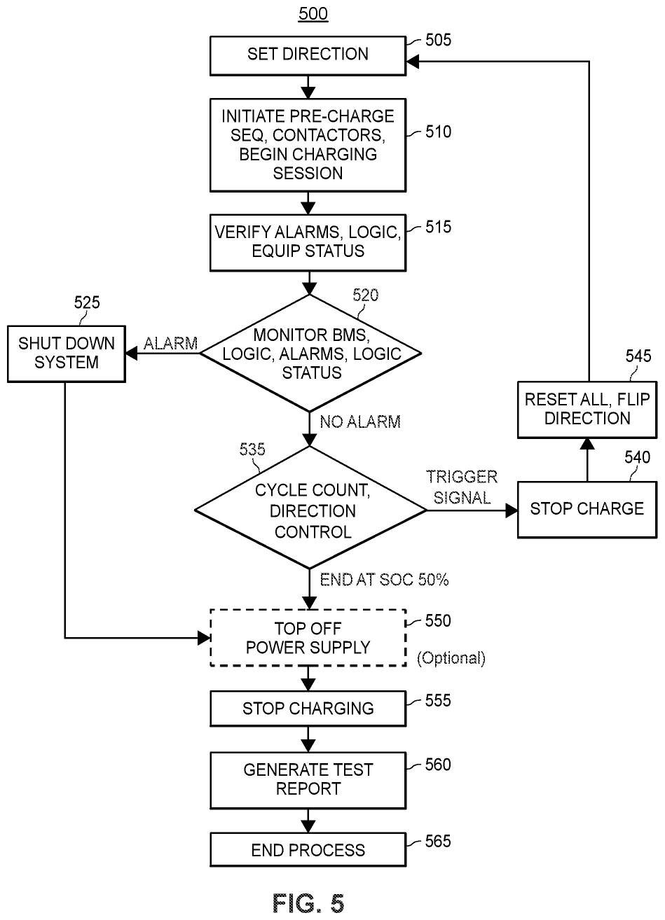

FIG. 5 shows an example method 500, including monitoring alarms, and ending at SOC 50%. The example method 500 may be performed by the controller 350 in communication with various other components of the system 300, the BMS 314, and the BMS 324.

At block 505, the example method 500 begins by the controller 350 setting a direction for charging. For example, the direction is set to charge either of the first battery stack 312 or the second battery stack 322. The direction may be set based on which battery stack 312, 322 is to be charged. Setting the charging direction may comprise setting a flag indicative of a direction of charging, which will be used to control the opening and closing of the contactors K1-K7 to control the direction of charging.

At block 510, a pre-charge sequence is initiated in order to begin the charging session. The pre-charge sequence may comprise preparatory actions prior to charging, such as setting the states of contactors K1-K7, powering the switch mode power supply 330, and verifying the statuses of the components of the system 300.

At block 515, the alarms, logic, and equipment status of the components of the system 300, the first battery assembly 310, and the second battery assembly 320 are verified. Such verification may include communication between the controller 350 and the BMSs 314, 324. At block 520, the controller 350 monitors the BMSs 314, 324, the logic circuit 370, the alarms, and/or the logic status.

If there is an alarm detected at block 520, the system shuts down at block 525. That is, the switch mode power supply 330 is shut down, and/or the contactors K1-K7 are all opened. At block 555, the charging session is then stopped.

If there is no alarm detected at block 520, the appropriate battery stack 312 or 322 is charged, and the cycle count is determined at block 535. If a trigger event is detected, the controller 350 generates a trigger signal that causes the system to stop charging the battery stack 312 or 322 at block 540. For example, to stop charging the battery stacks 312, 322, the controller 350 may open the contactors K1-K7. The trigger signal may be associated with either the first or second trigger event (depending on which battery stack 312, 322 is being charged) described above (e.g., the SOC of the battery being charged reaches a charge completion threshold, such as 75% SOC, 80% SOC, 83% SOC, 85% SOC, 88% SOC, 90% SOC, 93% SOC, 95% SOC, 98% SOC, etc.).

At block 545, the controller causes the system to flip the direction of charging. For example, if the contactors K1-K7 were previously configured to charge the first battery stack 312 from the second battery stack 322, the system opens and closes contactors to charge the second battery stack 322 from the first battery stack 312. Subsequently, the example method 500 returns to block 505 to set the direction of charging.

If, at block 535, a flag has been set to end the cycle based upon reaching the predetermined number of cycles, the controller 350 stops the current cycle when the SOC of the discharging battery stack (i.e., battery stack 312 or 322) drops to a predetermined level (e.g., at 50% SOC). In some embodiments, the top off power supply 340 is optionally activated at block 550 to bring the charging battery stack (i.e., battery stack 322 or 312) up to a predetermined level (e.g., at 50% SOC). The charging session is then stopped at block 555.

At block 560, a test report is generated. The test report may include a number of cycles that one or both of the battery stacks 312, 322 have completed, alarms (if any), SOC histories of one or both of the battery stacks 312, 322, date and time of the charging session, etc. The test report may be stored for later analysis.

At block 565, the example method 500 ends. The battery assemblies 310 and 320 may then be disconnected from the system 300 and installed within EV charging stations as energy storage modules 114 of EV charging systems 100.

Further regarding the example flowcharts provided above, it should be noted that all blocks are not necessarily required to be performed. Moreover, additional blocks may be performed although they are not specifically illustrated in the example flowcharts. In addition, the example flowcharts are not mutually exclusive. For example, block(s) from one example flowchart may be performed in another of the example flowcharts. It should be appreciated that the principles of any of the flowcharts described in this application may apply to EV charging station batteries and/or EV batteries.

### Example EV Charging and Discharging Systems—More than Two Battery Assemblies

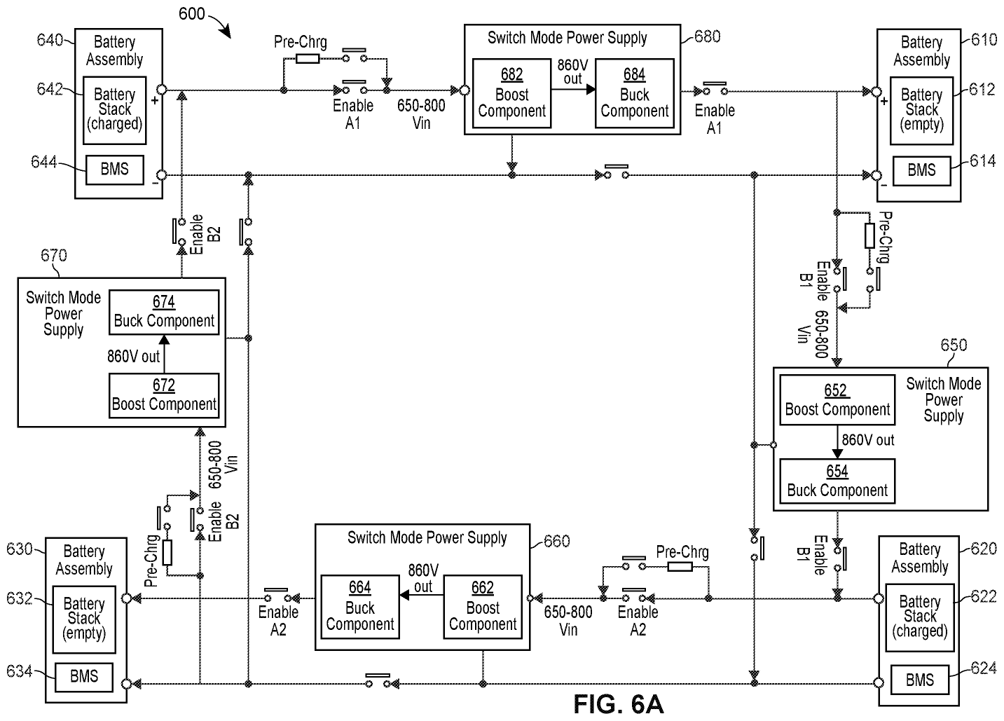

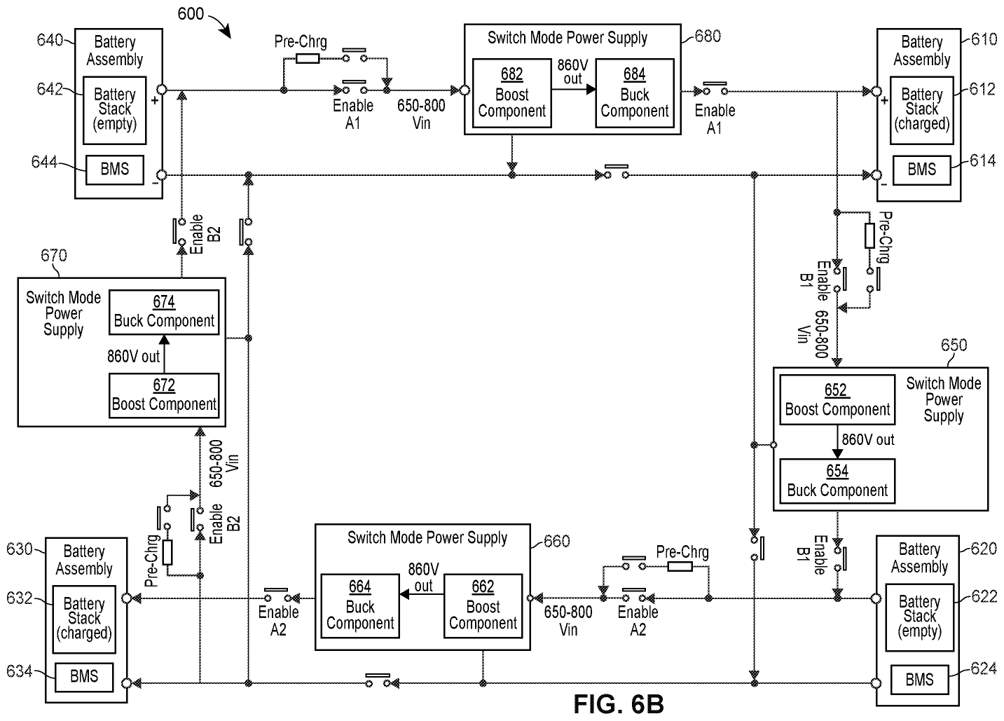

Some embodiments include more than two battery assemblies. To this end, FIGS. 6A and 6B illustrate an example system 600 including four battery assemblies, with FIG. 6A illustrating a first cycle, and FIG. 6B illustrating a second cycle. However, it should be appreciated that the principles discussed with respect to FIGS. 6A and 6B apply equally to systems with any number of battery assemblies.

Broadly speaking, the example system 600 includes two groups of battery assemblies (e.g., with the first group being battery assemblies 610, 630, and the second group being 620, 640). The example system 600 may then alternatingly charge/discharge each group. For instance, as illustrated in FIG. 6A, during the first cycle, the second group of battery assemblies 620, 640 starts as charged, and the first group of battery assemblies 610, 630 starts as discharged. Thus, in the first cycle of the illustrated example, the second group of battery assemblies 620, 640 charges the first group being battery assemblies 610, 630. Following the first cycle, enters a second cycle (illustrated in FIG. 6B) where the first groups of battery assemblies 610, 630 has been charged, while the second group of battery assemblies has been discharged. Thus, in the second cycle of the illustrated example, the first group of battery assemblies 610, 630, charges the second group of battery assemblies 620, 640.

Each of the respective battery assemblies 610, 630 of the first group of battery assemblies may include a respective battery stack 612, 632. The battery stacks 612, 632 may correspond to the battery stack 208 illustrated in FIG. 2 and/or batteries of the energy storage module 114 illustrated in FIG. 1. As mentioned above, one purpose of the system 600 is to sufficiently charge and discharge the battery stack 612, 632 during their first two to three initial cycles to thereby improve battery life and performance. Additionally, however, the system 600 allows charge to flow in one direction, using multiple switch mode power supplies each disposed between pairs of battery assemblies and configured to transfer charge in only one direction between the battery assemblies of such corresponding pair. For example, switch mode power supply 650 is disposed between battery assemblies 610 and 620 and is configured to transfer charge from battery assembly 610 to battery assembly 620, while switch mode power supply 660 is disposed between battery assemblies 620 and 630 and is configured to transfer charge from battery assembly 620 to battery assembly 630.

The battery assemblies 610, 630 further include respective BMSs 614, 634. The respective BMSs 614, 634 may monitor and/or record any characteristics or events of the respective battery stacks 612, 632. For example, the respective BMSs 614, 634 may monitor and/or record: a state of charge (SOC) of the respective battery stacks 612, 632, an input current of the respective battery stacks 612, 632, an input voltage of the respective battery stacks 612, 632, an output current of the respective battery stacks 612, 632, and/or an output voltage of the respective battery stacks 612, 632. Additionally or alternatively, the respective battery management systems 614, 634 may send signal(s) indicating a voltage and/or current level for charging the respective battery stacks 612, 632. Additionally or alternatively, in some embodiments, the respective BMSs 614, 634 may generate trigger signals relating to the SOC of the respective battery stacks 612, 632 and/or create a log of events for the respective battery stacks 612, 632 (e.g., starting and ending times of charging or discharging, measured voltage levels, or measured current levels).

The illustrated example system 600 further includes a second group of battery assemblies, which may include battery assembly 620 and battery assembly 640. Each of the respective battery assemblies 620, 640 of the second group of battery assemblies includes a battery stack 622, 644. The battery stacks 622, 642 may (similarly to the battery stacks 612, 632) correspond to the battery stack 208 illustrated in FIG. 2 and/or batteries of the energy storage module 114 illustrated in FIG. 1. As mentioned above, one purpose of the system 600 is to sufficiently charge and discharge the battery stacks 622, 642 during their first two to three initial cycles to thereby improve battery life and performance.

The battery assemblies 620, 640 further include respective BMSs 624, 644. The respective BMSs 624, 644 may monitor and/or record any characteristics or events of the respective battery stacks 622, 642. For example, the respective BMSs 624, 644 may monitor and/or record: a state of charge (SOC) of the respective battery stacks 622, 642, an input current of the respective battery stacks 622, 642, an input voltage of the respective battery stacks 622, 642, an output current of the respective battery stacks 622, 642, and/or an output voltage of the respective battery stacks 622, 642. Additionally or alternatively, the respective battery management systems 624, 644 may send signal(s) indicating a voltage and/or current level for charging the respective battery stacks 622, 642. Additionally or alternatively, in some embodiments, the respective BMSs 624, 644 may generate trigger signals relating to the SOC of the respective battery stacks 622, 642 and/or create a log of events for the respective battery stacks 622, 642 (e.g., starting and ending times of charging or discharging, measured voltage levels, or measured current levels).

The example system 600 may further include switch mode power supplies 650, 660, 670, 680. In some examples, the switch mode power supplies 650, 660, 670, 680 receive an input voltage from the battery stack being discharged. In the example of FIG. 6A, the battery stacks 622, 642 are being discharged in order to charge battery stacks 632, 612, respectively, and thus the input voltage Vᵢₙ of the switch mode power supply 660, 680 is received respectively from the respective battery stack 622, 642. In some examples, the voltage received from the discharging battery stack ranges from approximately 650V to 800V. For instance, initially, if the battery stack 622, 642 starts from fully charged, it may provide a voltage of approximately 800V to the respective switch mode power supply 660, 680; and, as the SOC of the battery stack 622, 642 depletes, the input voltage Vᵢₙ is reduced to approximately 650V.

The switch mode power supplies 650, 660, 670, 680 may output an output voltage to the battery stack being charged, which, in the example of FIG. 6A, is battery stacks 632, 612. The switch mode power supplies 650, 660, 670, 680 may allow the output voltage Vₒᵤₜ to vary (e.g., from 650V to 800) so that the charging current (e.g., the current output by the switch mode power supplies 650, 660, 670, 680 to the battery stack being charged) may vary to reach a particular level. For example, the respective BMS 614, 624, 634, 644 may request a charging current level (e.g., 10A, 15A, 20A, 88A, etc.), and the respective switch mode power supply 650, 660, 670, 680 may allow the output voltage to vary so that the charging current may reach the level requested by the respective BMS 614, 624, 634, 644. However, it should be understood that this is just one example, and the charging current may be determined by other techniques as well.

The respective switch mode power supplies 650, 660, 670, 680 may be considered to include a respective boost component 652, 662, 672, 682 and a buck component 654, 664, 674, 684, which operate together to provide the desired output voltage Vₒᵤₜ. Thus, the respective boost component 652, 662, 672, 682 may step up the input voltage Vᵢₙ supplied to the respective switch mode power supply 650, 660, 670, 680, and the buck component 654, 664, 674, 684 may step down the voltage to supply the output voltage Vₒᵤₜ from the respective switch mode power supply 650, 660, 670, 680. For instance, in the example of FIG. 6A, the respective boost component 652, 662, 672, 682 converts the input voltage to a boosted voltage of 860V (or any other suitable voltage, such as any voltage between 750V and 950V), which is above the desired charging voltage for the battery stack 612, 622, 632, 642. The respective buck component 654, 664, 674, 684 may then reduce the boosted voltage from 860V to 800V (or any other suitable voltage, such as any voltage between 700V and 900V) and output the 800V output voltage Vₒᵤₜ to the battery stack being charged. Thus, the buck component 654, 664, 674, 684 may allow the output voltage to vary (e.g., from 650V to 800V) so that the charging current may vary to reach a particular level.

Although not shown in the FIG. 6A, the example system 600 may further include one or more top off power supplies. In some examples, the top off power supplies are used to replace power that is dissipated throughout the process of charging and recharging the battery stacks 612, 622, 632, 642 due to inherent losses in the various system components and connections. In one working example, for full charge, the battery stack 612 would need 160 kWh; however, once the battery stack 642 is depleted, the battery stack 612 has only reached 150 kWh, so the top off power supply provides the remaining 10 kWh. In some embodiments, the top off power supply provides a low current (e.g., less than 10 A) to the battery stack being charged because the battery being charged is close to being fully charged. In some embodiments, the top off power supply includes a transformer to increase its voltage to, for example, 806V or more; for example, a fully charged battery stack may be 806V so the top off power supply may go at least this high. In some embodiments, the top off power supply provides a charging current to the battery stack 612, 622, 632, 642 requested, respectively, by the BMS 614, 624, 634, 644.

Any of the BMS 614, 624, 634, 644 may provide signals to a controller (e.g., also not shown in the example FIG. 6A; and similar to the controller 350 of FIG. 3), which may comprise one or more processors, and which may control the Enable A1, Enable A2, Enable B1, Enable B2 and/or other components throughout the system 600. For instance, the controller may detect a first trigger signal from any of the BMS 614, 624, 634, 644; and, in response to the detection of the first trigger signal, the controller may open or close contactors to cause one of the battery stacks 612, 622, 632, 642 to charge another of the battery stacks 612, 622, 632, 642. For example, to charge the battery stack 612 from the battery stack 642, the controller may close contactors A1. In another example, to charge the battery stack 622 from the battery stack 612, the controller may close contactors B1.

As this illustrates, upon detection of the first trigger signal, the example system 600 may enter a second cycle, which is illustrated by the example of FIG. 6B. At the beginning of this second cycle, as illustrated, battery stacks 612, 632 are fully charged, whereas battery stacks 622, 642 are empty. In one example of this, during the second cycle: battery stack 612 charges battery stack 622 (e.g., contactors Enable B1 are closed, and Enable A1 are open), and battery stack 632 charges battery stack 642 (e.g., contactors Enable B2 are closed, and Enable A2 are open).

Additionally, or alternatively, the controller may detect a second trigger signal from any of the BMS 614, 624, 634, 644; and, in response to the detection, open or close contactors to charge any the battery stacks 612, 622, 632, 642 from the top off power supply. To control the contactors, the controller may be connected to a digital I/O controller (e.g., similar to DIO 360), which may in turn control the contactors A1, A2, B1, B2 via a logic circuit (e.g., similar to logic circuit 370). In some embodiments, the logic circuit does not allow forward and reverse directions on at the same time. For example, the logic gates within the logic circuit may not allow the forward and reverse directions to be on at the same time, even if it received both a forward and reverse signal from the digital I/O controller. Furthermore, the logic circuit may set flags. For example, a flag may be set to indicate the direction of charging (e.g., indicating if the first group of battery stacks is to be charged or the second group of battery stacks is to be charged). In another example, a flag may be set indicating that a predetermined number of cycles has been reached (e.g., the first group of battery stacks has been charged and discharged twice, etc.).

Furthermore, although FIGS. 6A and 6B illustrate only four battery assemblies 610, 620, 630, 640, in accordance with the techniques described herein, any number of battery assemblies may be connected. For example, the example system 600 may transfer energy between any number of battery stacks, even though only four are shown in FIGS. 6A and 6B.

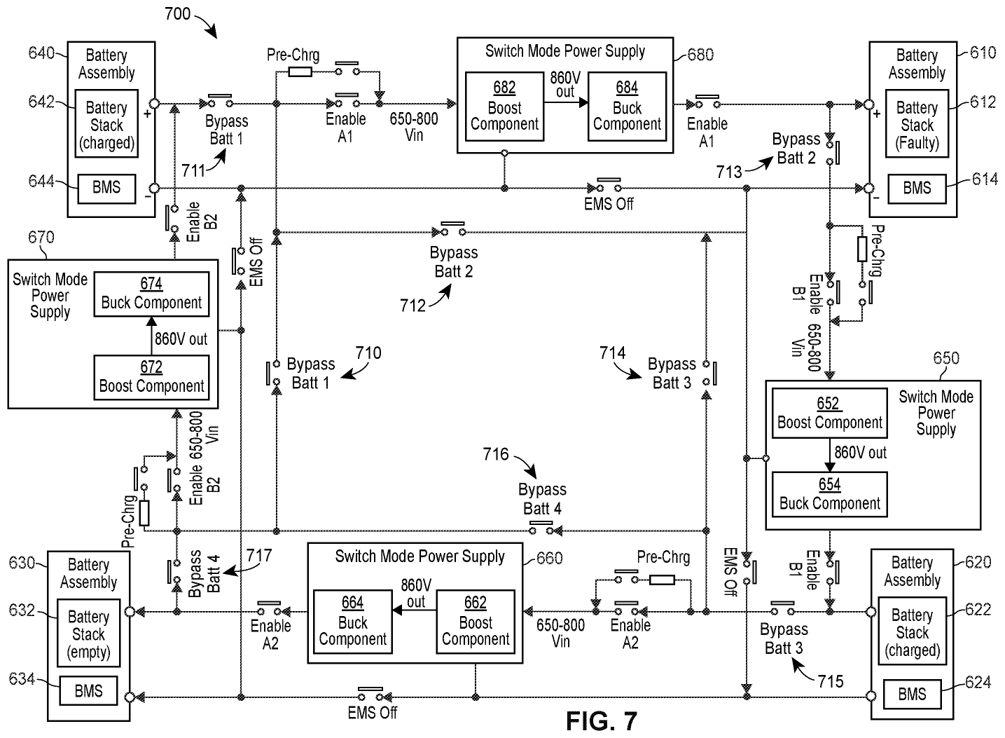

FIG. 7 illustrates an example system 700 including four battery assemblies 610, 620, 630, 640, and bypasses. Example system 700 is configured in a similar manner to example system 600, but system 700 includes respective bypass circuits allowing the bypass of any of the battery assemblies 610, 620, 630, 640 (e.g., allowing bypass of faulty battery assemblies). More particularly, the example system includes one bypass for each illustrated battery assembly: a bypass batt 1 (e.g., to bypass battery assembly 640); a bypass batt 2 (e.g., to bypass battery assembly 610); a bypass batt 3 (e.g., to bypass battery assembly 620); and a bypass batt 4 (e.g., to bypass battery assembly 630).

The controller, the digital I/O, and/or the logic circuit may control the bypass batt 1, bypass batt 2, bypass batt 3, and/or bypass batt 4. In particular, to control bypass batt 1, the controller, the digital I/O, and/or the logic circuit may control contactors 710, 711; to control bypass batt 2, the controller, the digital I/O, and/or the logic circuit may control contactors 712, 713; to control bypass batt 3, the controller, the digital I/O, and/or the logic circuit may control contactors 714, 715; and to control bypass batt 4, the controller, the digital I/O, and/or the logic circuit may control contactors 716, 717. Controlling the contactors of any bypass circuit will cause such bypass circuit to become active and bypass the respective switch mode power supply and battery assembly associated with such bypass circuit.

In one working example, the bypasses allow charging to continue when a defective battery assembly is encountered. In the example illustrated in FIG. 7, the battery stack 612 is faulty. To bypass battery stack 612, the contactor 713 may be opened, and the contactor 712 may be closed. Further advantageously, the bypass systems may be used to bypass defective switch mode power supplies.

Furthermore, although FIG. 7 illustrates only four battery assemblies 610, 620, 630, 640, in accordance with the techniques described herein, any number of battery assemblies and bypasses may be connected. For example, the system may transfer energy between any number of battery stacks, even though only four are shown in FIG. 7.

### Example Methods—More Than Two Battery Assemblies

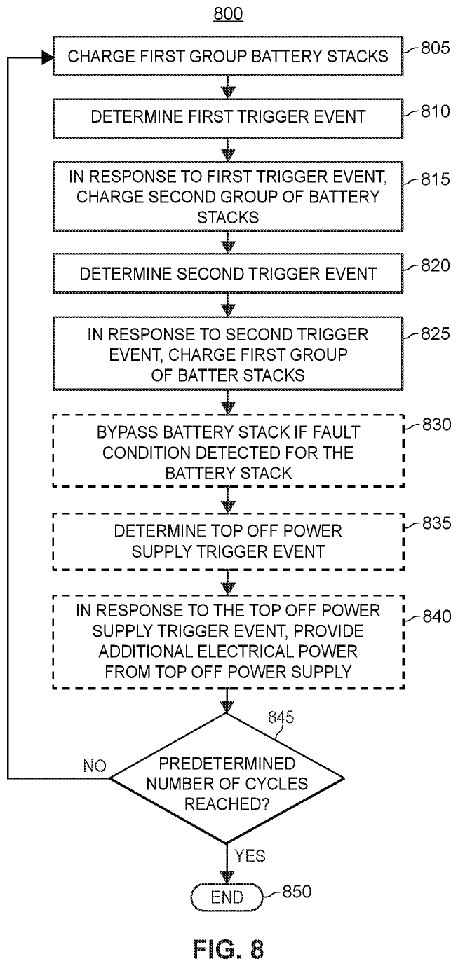

FIG. 8 illustrates a flowchart of an example method 800 for charging and discharging EV charging station batteries and/or EV batteries, including charging multiple groups of EV charging station batteries. To illustrate the principles discussed herein, the example method 800 begins with the first group of battery stacks 612, 632 initially discharged, and the second group of battery stacks 622, 642 initially charged. The second group of battery stacks 622, 642 may be initially charged by any known techniques using any power supply.

At block 805, the first group of battery stacks 612, 632 may be charged from the second group of battery stacks 622, 642 by: (i) providing electrical power from the second group of battery stacks 622, 642 to the switch mode power supplies 660, 680, and (ii) providing electrical power from the switch mode power supplies 660, 680 to the first group of battery stacks 612, 632. Thus, battery stack 612 is charged from battery stack 642 via switch mode power supply 680, and battery stack 632 is charged from battery stack 622 via switch mode power supply 660. For example, the contactors Enable A1, Enable A2, Enable B1, Enable B2 may be controlled by the controller to provide power in this way, as described above with respect to FIGS. 6A, 6B, and 7.

To further elaborate, in some embodiments, the boost components 662, 682 of the switch mode power supplies 660, 680 receive input voltages respectively from the battery stacks 622, 642, and then output boosted output voltages respectively to the buck components 664, 684. In some examples, the voltages that the boost component 662, 682 output to the buck component 664, 684 are greater than the voltages than the buck component 664, 684 will output to the battery stack 630, 610, which facilitates each of the buck component 664, 684 to allow the voltage that it outputs to the battery stack 630, 610 to vary according to a desired charging current level. In some examples, the desired charging current level may be a current level requested by the BMS 614, 634; for example, the BMS 614, 634 may determine the desired current charging level (e.g., based on the SOC of the battery stack 612, 632), and send the desired charging current level to the controller. In other examples, the BMS 614, 634 may send the SOC of the battery stack 612, 632 to the controller, and the controller may determine the desired charging current level based on the SOC.

At block 810, a first trigger event is determined (e.g., by the controller) to have occurred during charging of the first group of battery stacks 612, 632. In some examples, the first trigger event may be an event associated with an SOC of a battery stack of the first group of battery stacks 610, 630. For example, the first trigger event may comprise an SOC of the first plurality of SOCs (e.g., SOC of either the battery stack 612 or the battery stack 632) exceeding a battery stack charge completion threshold (e.g., approximately 75%, 80%, 83%, 85%, 88%, 90%, 93%, 95%, 98%, etc.). In another example, the first trigger may be an event associated with a number (e.g., two, four, ten, all, etc.) of the SOCs of the battery stacks of the first group of battery stacks exceeding a battery stack charge completion threshold (e.g., approximately 75%, 80%, 85%, 88%, 90%, 93%, 95%, 98%, etc.).

To determine if the first trigger event has occurred, the BMS 614, 634 may send respective battery stack charge status signals indicating the SOCs of the respective battery stacks 612, 632 to the controller, and thus the controller may determine the first trigger event. Alternatively, the BMS 614, 634 may monitor the respective SOCs, and generate and send a first trigger event signal to the controller.

In other examples, the first trigger event may be an event associated with an SOC of a battery stack of the second group of battery stacks 622, 642. For example, the first trigger event may comprise the SOC of the second group of battery stacks 622, 642 falling below a battery stack charge depletion threshold (e.g., approximately 20% SOC, 15% SOC, 10% SOC, 8% SOC, 5% SOC, 4% SOC, 2% SOC, etc.). In another example, the first trigger may be an event associated with a number (e.g., two, four, ten, all, etc.) of the SOCs of the battery stacks of the second group of battery stacks falling below a battery stack charge depletion threshold (e.g., approximately 20% SOC, 15% SOC, 10% SOC, 8% SOC, 5% SOC, 4% SOC, 2% SOC, etc.).

To determine if the first trigger event has occurred, the BMS 624, 644 may send a second battery stack charge status signal indicating the second SOC of the second battery stack 622, 642 to the controller, and thus the controller may determine the first trigger event. Alternatively, the BMS 624, 644 may monitor the respective SOC, and generate and send a first trigger event signal to the controller.

In still other examples, the first trigger event may be an event associated with both the first group of battery stacks 610, 630, and an SOC of the second group of battery stacks 622, 642. For example, the first trigger event may be determined when either an SOC of the first group of battery stacks 610, 630 exceeds a battery stack charge completion threshold or the SOC of the second group of battery stacks 622, 642 falls below a battery stack charge depletion threshold. In another example, the first trigger event may be determined when both an SOC of the first group of battery stacks 610, 630 exceeds a battery stack charge completion threshold and the SOC of the second group of battery stacks 622, 642 falls below a battery stack charge depletion threshold.

At block 815, in response to determining occurrence of the first trigger event, the second group of battery stacks 622, 642 is charged by: (i) providing electrical power from the first group of battery stacks 610, 630 to the switch mode power supplies 650, 670, and (ii) providing electrical power from the switch mode power supplies 650, 670 to the second group of battery stacks 622, 642. Thus, battery stack 622 is charged from battery stack 612 via switch mode power supply 650, and battery stack 642 is charged from battery stack 632 via switch mode power supply 670. For example, the contactors Enable A1, Enable A2, Enable B1, Enable B2 may be controlled by the controller to provide power in this way, as described above with respect to FIGS. 6A, 6B, and 7.

At block 820, a second trigger event is determined (e.g., by the controller) to have occurred during charging of the second group of battery stacks 622, 642. Such second trigger event may be similar to the first trigger event. In some examples, the second trigger event may be an event associated with an SOC of the second group of battery stacks 622, 642. For example, the second trigger event may comprise the SOC of the second group of battery stacks 622, 642 exceeding a battery stack charge completion threshold (e.g., approximately 75%, 85%, 88%, 90%, 93%, 95%, 98%, etc.). For example, the BMS 624, 644 may send a second battery stack charge status signal indicating the respective SOC of the battery stack 622, 642 to the controller, and thus the controller may determine the second trigger event. Alternatively, the BMS 624, 644 may monitor the respective SOC, and generate and send a second trigger event signal to the controller.

In other examples, the second trigger event is an event associated with an SOC of the first group of battery stacks 610, 630. For example, the second trigger event may comprise the a SOC of the first group of battery stacks 610, 630 falling below a battery stack charge depletion threshold (e.g., approximately 20% SOC, 15% SOC, 10% SOC, 8% SOC, 5% SOC, 4% SOC, 2% SOC, etc.). For example, the BMS 614, 634 may send a first battery stack charge status signal indicating the respective SOC to the controller, and thus the controller may determine the second trigger event. Alternatively, the BMS 614, 634 may monitor the respective SOC, and generate and send a second trigger event signal to the controller.

In still other examples, the second trigger event may be an event associated with both the first group of battery stacks 610, 630, and an SOC of the second group of battery stacks 622, 642. For example, the second trigger event may be determined when either an SOC of the second group of battery stacks 622, 642 exceeds a battery stack charge completion threshold or the SOC of the first group of battery stacks 610, 630 falls below a battery stack charge depletion threshold. In another example, the second trigger event may be determined when both an SOC of the second group of battery stacks 622, 642 exceeds a battery stack charge completion threshold and the SOC of the first group of battery stacks 610, 630 falls below a battery stack charge depletion threshold.

At block 825, in response to determining occurrence of the second trigger event, the first group of battery stacks 610, 630 is charged by: (i) providing electrical power from the second group of battery stacks 622, 642 to the switch mode power supplies 660, 680, and (ii) providing electrical power from the switch mode power supplies 660, 680 to the first group of battery stacks 610, 630. For example, the contactors Enable A1, Enable A2, Enable B1, Enable B2 may be controlled by the controller to provide power in this way, as described above with respect to FIGS. 6A, 6B, and 7.

At optional block 830, the controller determines if there is a fault condition in any of the battery stacks 612, 622, 632, 642. If so, the controller bypasses the battery stack 612, 622, 632, 642 with the fault condition. For example, to bypass a battery stack 612, 622, 632, 642, the controller may open or close any of contactors 710, 711, 712, 713, 714, 715, 716, 717, as described above with respect to FIG. 7.

At optional block 835, the controller determines if there is a top off power supply trigger event. In some embodiments, this is done in response to the determination of the second trigger event. For example, the second trigger event may indicate that the an SOC first group of battery stacks 610, 630 has fallen below a certain level, so that a battery stack 612 or 632 is no longer able to effectively charge one of the second battery stacks 622, 642. In response to this determination, the controller may determine if there is also a top off power supply trigger event. If so, the system will supply power from a top off power supply to the particular second battery stack 622, 642. In some examples, the top off power supply trigger event comprises the SOC of a battery stack of the second group of battery stacks 622, 642 being below a charge completion threshold (e.g., 75% SOC, 80% SOC, 83% SOC, 85%, 88% SOC, SOC, 90%, 93% SOC, SOC, 95%, 98% SOC, SOC, etc.).

In some embodiments, the controller determines the top off power supply trigger event by receiving SOC signals from the BMS 614, 624, 634, and/or 644. Additionally or alternatively, the BMS 614, 624, 634, and/or 644 may determine a top off power supply trigger signal and send it to the controller.

However, in some embodiments, the top off power supply trigger event and the second trigger event are combined into one determination. For instance, the top off power supply trigger event may be determined together with the second trigger event by determining that: (i) an SOC of the first group of battery stacks 610, 630 has fallen below a battery stack charge depletion threshold, and (ii) an SOC of the second group of battery stacks 622, 642 has not passed a battery stack charge completion threshold. Thus, in some embodiments, the second trigger event and the top off power supply trigger event do not need to be independently determined, and thus, in the example method 800, block 835 is illustrated as optional.

At optional block 840, if there has been a determination of the top off power supply trigger event (either separately or together with the determination of the second trigger event), the system provides electrical power from the top off power supply to the battery stack for which it has been determined needs the additional power (e.g., the battery stack for which it has been determined has not met its charge completion threshold). The top off power supply may then be used to continue charging the appropriate battery stack until it reaches a predetermined SOC threshold, which may be a threshold associated with the second trigger event, such as the second SOC exceeding a battery stack charge completion threshold (e.g., approximately 75%, 80%. 83%, 85%, 88%, 90%, 93%, 95%, 98%, etc.).

Additionally or alternatively, it should be understood that the optional blocks 835 and/or 840 may be performed at other points in the example method 800. For example, the optional blocks 835 and/or 840 may be performed following block 825, and prior to optional block 830. In another example, the top off power supply may supply power to a first battery stack of the first group of battery stacks 610, 630. In this example, optional blocks 835 and/or 840 may be performed along with, immediately preceding, or immediately following block 810.

In any event, at block 845 it is determined (e.g., by the controller) if a predetermined number of cycles is reached. The predetermined number of cycles may be any number of cycles (e.g., 1 cycle, 2, cycles, 3 cycles, etc.). In some embodiments, a cycle is counted as a battery stack (or predetermined number of battery stacks) having been both fully charged (e.g., SOC greater than 75%; SOC greater than 80%; SOC greater than 83%; SOC greater than 85%; SOC greater than 88%; SOC greater than 90%; SOC greater than 93%; SOC greater than 95%; SOC greater than 98%; etc.) and fully discharged (e.g., SOC less than 2%; SOC less than 4%; SOC less than 5%; SOC less than 8%; SOC less than 10%; SOC less than 15%; SOC less than 20%; etc.). The determination may be made based on one of the battery stacks 612, 624, 634, 644 individually; groups of the battery stacks, or any combination of the battery stacks 612, 624, 634, 644.

In some embodiments, the BMSs 614, 624, 634, 644 send SOC signals to the controller, and the controller makes the determination if the predetermined number of completed cycles has been reached. In some embodiments, any of the BMSs 614, 624, 634, 644 log information regarding the cycles and send cycle complete signals to the controller.

If the predetermined number of cycles has not been reached, the example method 800 returns to block 805, and the first group of battery stacks 610, 630 are again charged. If the predetermined number of cycles has been reached, the example method 800 ends at block 850.

In addition, it should be understood that not all blocks and/or events of the exemplary flowcharts 400, 800 are required to be performed. Moreover, the exemplary flowcharts 400, 800 are not mutually exclusive (e.g., block(s)/events from each example flowchart 400, 800 may be performed in the other flowchart 400, 800). In addition, the blocks of each example flowchart 400, 800 may be performed in any order. The exemplary flowcharts 400, 800 may include additional, less, or alternate functionality, including that discussed elsewhere herein.

### Example Embodiments—More Than Two Battery Assemblies

Aspect 1. A computer-implemented method for charging and discharging electric vehicle (EV) charging station batteries and/or EV batteries, the method comprising:
charging a first group of battery stacks comprising a first plurality of battery stacks by: (i) providing electrical power from a second group of battery stacks comprising a second plurality of battery stacks to switch mode power supplies, and (ii) providing electrical power from the switch mode power supplies to the first group of battery stacks;
determining, by a controller, occurrence of a trigger event associated with a first plurality of states of charge (SOCs) associated with the first group of battery stacks or a second plurality of SOCs associated with the second group of battery stacks; and
in response to determining occurrence of the trigger event, charging the second group of battery stacks by: (i) providing electrical power from the first group of battery stacks to the switch mode power supplies, and (ii) providing electrical power from the switch mode power supplies to the second group of battery stacks.

Aspect 2. The method of aspect 1, wherein:
battery stacks of the first group of battery stacks are electrically coupled to respective battery management systems (BMSs), each respective BMS of the first group of battery stacks being configured to generate a charge status signal indicating a SOC of a respective battery stack of the first group of battery stacks.

Aspect 3. The method of aspect 2, wherein the trigger event comprises an SOC of the first plurality of SOCs exceeding a battery stack charge completion threshold of at least approximately 85% SOC.

Aspect 4. The method of aspect 1, wherein:
battery stacks of the second group of battery stacks are electrically coupled to respective battery management systems (BMSs), each respective BMS of the second group of battery stacks being configured to generate a charge status signal indicating a SOC of a respective battery stack of the second group of battery stacks.

Aspect 5. The method of aspect 4, wherein the trigger event comprises an SOC of the second plurality of SOCs not exceeding a battery stack charge depletion threshold of less than approximately 10% SOC.

Aspect 6. The method of aspect 1, wherein at least one switch mode power supply of the switch mode power supplies comprises:
a boost component configured to: (i) receive an input voltage from a first battery stack of the first group of battery stacks and (ii) output a boosted output voltage to a buck component; and
the buck component configured to: (i) receive the boosted output voltage and (ii) output a charging current to a second battery stack of the second group of battery stacks.

Aspect 7. The method of aspect 6, wherein the charging current is determined based on a charging current signal generated by: (i) a first battery management system (BMS) electrically coupled to the first battery stack, or (ii) a second BMS electrically coupled to the second battery stack.

Aspect 8. The method of aspect 6, wherein:
the boosted output voltage is approximately 860V; and
the received input voltage is between approximately 600V and 810V.

Aspect 9. The method of aspect 1, further comprising:
determining, by the controller, occurrence of a top off power supply trigger event associated with an SOC of a first battery stack of the first group of battery stacks or an SOC of a second battery stack of the second group of battery stacks; and
in response to determining occurrence of the top off power supply trigger event, providing, from a top off power supply, additional electrical power to the second battery stack of the second group of battery stacks.

Aspect 10. The method of aspect 9, wherein determining the top off power supply trigger event comprises determining that: (i) the first SOC of the first battery stack has fallen below a battery stack charge depletion threshold, and (ii) the second SOC of the second battery stack has not passed a battery stack charge completion threshold.

Aspect 11. The method of aspect 1, further comprising:
detecting, by the controller, a fault condition of a first battery stack of the first group of battery stacks; and
in response to the detection of the fault condition, bypassing, by the controller, the first battery stack of the first group of battery stacks.

Aspect 12. The method of aspect 1, wherein:
the first plurality of battery stacks comprises a first battery stack and a third battery stack;
the second plurality of battery stacks comprises a second battery stack and a fourth battery stack;
the switch mode power supplies comprise a first switch mode power supply, a second switch mode power supply, a third switch mode power supply, and a fourth switch mode power supply;
charging the first group of battery stacks comprises:
(i) providing electrical power from the fourth battery stack to the fourth switch mode power supply, and (ii) providing electrical power from the fourth switch mode power supply to the first battery stack; and
(i) providing electrical power from the second battery stack to the second switch mode power supply, and (ii) providing electrical power from the second switch mode power supply to the third battery stack; and
charging the second group of battery stacks comprises:
(i) providing electrical power from the first battery stack to the first switch mode power supply, and (ii) providing electrical power from the first switch mode power supply to the second battery stack; and
(i) providing electrical power from the third battery stack to the third switch mode power supply, and (ii) providing electrical power from the third switch mode power supply to the fourth battery stack.

Aspect 13. A non-transitory computer-readable storage medium for charging and discharging electric vehicle (EV) charging station batteries and/or EV batteries comprising instructions that, when executed by one or more processors of a controller of a system, cause the controller to control the system to:
charge a first group of battery stacks comprising a first plurality of battery stacks by: (i) providing electrical power from a second group of battery stacks comprising a second plurality of battery stacks to switch mode power supplies, and (ii) providing electrical power from the switch mode power supplies to the first group of battery stacks;
determine occurrence of a trigger event associated with a first plurality of states of charge (SOCs) associated with the first group of battery stacks or a second plurality of SOCs associated with the second group of battery stacks; and
in response to determining occurrence of the trigger event, charge the second group of battery stacks by: (i) providing electrical power from the first group of battery stacks to the switch mode power supplies, and (ii) providing electrical power from the switch mode power supplies to the second group of battery stacks.

Aspect 14. The non-transitory computer-readable storage medium of aspect 13, wherein:
battery stacks of the first group of battery stacks are electrically coupled to respective battery management systems (BMSs), each respective BMS of the first group of battery stacks being configured to generate a charge status signal indicating a SOC of a respective battery stack of the first group of battery stacks.

Aspect 15. The non-transitory computer-readable storage medium of aspect 14, wherein the trigger event comprises an SOC of the first plurality of SOCs exceeding a battery stack charge completion threshold of at least approximately 85% SOC.

Aspect 16. The non-transitory computer-readable storage medium of aspect 13, wherein:
battery stacks of the second group of battery stacks are electrically coupled to respective battery management systems (BMSs), each respective BMS of the second group of battery stacks being configured to generate a charge status signal indicating a SOC of a respective battery stack of the second group of battery stacks.

Aspect 17. The non-transitory computer-readable storage medium of aspect 16, wherein the trigger event comprises an SOC of the second plurality of SOCs not exceeding a battery stack charge depletion threshold of less than approximately 10% SOC.

Aspect 18. The non-transitory computer-readable storage medium of aspect 13, wherein at least one switch mode power supply of the switch mode power supplies comprises: a boost component configured to: (i) receive an input voltage from either a first battery stack of the first group of battery stacks and (ii) output a boosted output voltage to a buck component; and the buck component configured to: (i) receive the boosted output voltage and (ii) output a charging current to a second battery stack of the second group of battery stacks.

Aspect 19. The non-transitory computer-readable storage medium of aspect 18, wherein the charging current is determined based on a charging current signal generated by: (i) a first battery management system (BMS) electrically coupled to the first battery stack, or (ii) a second BMS electrically coupled to the second battery stack.

Aspect 20. The non-transitory computer-readable storage medium of aspect 18, wherein:
the boosted output voltage is approximately 860V; and
the received input voltage is between approximately 600V and 810V.

Aspect 21. The non-transitory computer-readable storage medium of aspect 13, wherein the instructions, when executed, further cause the controller to control the system to:
determine occurrence of a top off power supply trigger event associated with an SOC of a first battery stack of the first group of battery stacks or an SOC of a second battery stack of the second group of battery stacks; and
in response to determining occurrence of the top off power supply trigger event, provide, from a top off power supply, additional electrical power to the second battery stack of the second group of battery stacks.

Aspect 22. The non-transitory computer-readable storage medium of aspect 13, wherein the instructions, when executed, further cause the controller to control the system to:
detect a fault condition of a first battery stack of the first group of battery stacks; and
in response to the detection of the fault condition, bypass the first battery stack of the first group of battery stacks.

Aspect 23. The method of aspect 1, wherein:
the first plurality of battery stacks comprises a first battery stack and a third battery stack;
the second plurality of battery stacks comprises a second battery stack and a fourth battery stack;
the switch mode power supplies comprise a first switch mode power supply, a second switch mode power supply, a third switch mode power supply, and a fourth switch mode power supply;
the instructions, when executed, further cause the controller to control the system to charge the first group of battery stacks by:
   (i) providing electrical power from the fourth battery stack to the fourth switch mode power supply, and (ii) providing electrical power from the fourth switch mode power supply to the first battery stack; and
   (i) providing electrical power from the second battery stack to the second switch mode power supply, and (ii) providing electrical power from the second switch mode power supply to the third battery stack; and
the instructions, when executed, further cause the controller to control the system to charge the second group of battery stacks by:
   (i) providing electrical power from the first battery stack to the first switch mode power supply, and (ii) providing electrical power from the first switch mode power supply to the second battery stack; and
   (i) providing electrical power from the third battery stack to the third switch mode power supply, and (ii) providing electrical power from the third switch mode power supply to the fourth battery stack.

### Other Matters

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “module” or “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Furthermore, the patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed:

1. A computer-implemented method for charging and discharging electric vehicle (EV) charging station batteries, the method comprising:
charging a first battery stack by: (i) providing electrical power from a second battery stack to a switch mode power supply, and (ii) providing electrical power from the switch mode power supply to the first battery stack;
determining, by a controller, occurrence of a trigger event associated with a first state of charge (SOC) of the first battery stack or a second SOC of the second battery stack; and
in response to determining occurrence of the trigger event, charging the second battery stack by: (i) providing electrical power from the first battery stack to the switch mode power supply, and (ii) providing electrical power from the switch mode power supply to the second battery stack.

2. The method of claim 1, further comprising:
receiving, at the controller from a first battery management system (BMS) electrically coupled to the first battery stack, a first battery stack charge status signal, wherein the first BMS is configured to generate the first battery stack charge status signal indicating the first SOC of the first battery stack.

3. The method of claim 2, wherein the trigger event comprises the first SOC exceeding a battery stack charge completion threshold of at least approximately 85% SOC.

4. The method of claim 1, further comprising:
receiving, at the controller from a second battery management system (BMS) electrically coupled to the second battery stack, a second battery stack charge status signal, wherein the second BMS is configured to generate the second battery stack charge status signal indicating the second SOC of the second battery stack.

5. The method of claim 4, wherein the trigger event comprises the second SOC not exceeding a battery stack charge depletion threshold of less than approximately 10% SOC.

6. The method of claim 1, wherein the switch mode power supply comprises:
a boost component configured to: (i) receive an input voltage from either the first battery stack or the second battery stack, and (ii) output a boosted output voltage to a buck component; and
the buck component configured to: (i) receive the boosted output voltage, and (ii) output a charging current to either of the first battery stack or the second battery stack.

7. The method of claim 6, wherein the charging current is determined based on a charging current signal generated by: (i) a first battery management system (BMS) electrically coupled to the first battery stack, or (ii) a second BMS electrically coupled to the second battery stack.

8. The method of claim 6, wherein:
the boosted output voltage is approximately 860V; and
the received input voltage is between approximately 600V and 810V.

9. The method of claim 1, further comprising:
determining, by the controller, occurrence of a top off power supply trigger event associated with the first SOC of the first battery stack or the second SOC of the second battery stack; and
in response to determining occurrence of the top off power supply trigger event, providing, from a top off power supply, additional electrical power to the second battery stack.

10. The method of claim 9, wherein determining the top off power supply trigger event comprises determining that: (i) the first SOC of the first battery stack has fallen below a battery stack charge depletion threshold, and (ii) the second SOC of the second battery stack has not passed a battery stack charge completion threshold.

11. A non-transitory computer-readable storage medium for charging and discharging electric vehicle (EV) charging station batteries comprising instructions that, when executed by one or more processors of a controller of a system, cause the controller to control the system to:
charge a first battery stack by: (i) providing electrical power from a second battery stack to a switch mode power supply, and (ii) providing electrical power from the switch mode power supply to the first battery stack;
determine occurrence of a trigger event associated with a first state of charge (SOC) of the first battery stack or a second SOC of the second battery stack; and
in response to the determination of occurrence of the trigger event, charge the second battery stack by: (i) providing electrical power from the first battery stack to the second battery stack, and (ii) providing electrical power from the switch mode power supply to the second battery stack.

12. The non-transitory computer-readable storage medium of claim 11, wherein the instructions, when executed, further cause the controller to control the system to:
receive, from a first battery management system (BMS) electrically coupled to the first battery stack, a first battery stack charge status signal, wherein the first BMS is configured to generate the first battery stack charge status signal indicating the first SOC of the first battery stack.

13. The non-transitory computer-readable storage medium of claim 11, wherein the instructions, when executed, further cause the controller to control the system to:
receive, from a second battery management system (BMS) electrically coupled to the second battery stack, a second battery stack charge status signal, wherein the second BMS is configured to generate the second battery stack charge status signal indicating the second SOC of the second battery stack.

14. The non-transitory computer-readable storage medium of claim 11, wherein the instructions, when executed, further cause the controller to control the system to:
determine an occurrence of a top off power supply trigger event associated with the first SOC of the first battery stack or the second SOC of the second battery stack; and
in response to the determination of the occurrence of the top off power supply trigger event, provide, from a top off power supply, additional electrical power to the second battery stack.

15. A system for charging and discharging electric vehicle (EV) charging station batteries, the system comprising:
a first battery assembly comprising: (i) a first battery stack, and (ii) a first battery management system (BMS), wherein the first BMS is configured to generate a first battery stack charge status signal indicating a first state of charge (SOC) of the first battery stack;
a second battery assembly comprising: (i) a second battery stack, and (ii) a second BMS, wherein the second BMS is configured to generate a second battery stack charge status signal indicating a second SOC of the second battery stack;
a switch mode power supply electrically connected to the first battery assembly and the second battery assembly; and
a controller communicatively connected to the first BMS, the second BMS, and the switch mode power supply and configured to:
control charging of the first battery stack until occurrence of a trigger event by: (i) providing electrical power from the second battery stack to the switch mode power supply and (ii) providing electrical power from the switch mode power supply to the first battery stack;
determine occurrence of the trigger event based upon the first SOC or the second SOC; and
in response to determining occurrence of the trigger event, control charging of the second battery stack by: (i) providing electrical power from the first battery stack to the switch mode power supply and (ii) providing electrical power from the switch mode power supply to the second battery stack.

16. The system of claim 15, wherein the trigger event comprises the first SOC exceeding a battery stack charge completion threshold of at least approximately 85% SOC.

17. The system of claim 15, wherein the trigger event comprises the second SOC not exceeding a battery stack charge depletion threshold of less than approximately 10% SOC.

18. The system of claim 15, wherein the switch mode power supply comprises:
a boost component configured to: (i) receive an input voltage from either the first battery stack or the second battery stack, and (ii) output a boosted output voltage to a buck component; and
the buck component configured to: (i) receive the boosted output voltage, and (ii) output a charging current to either of the first battery stack or the second battery stack.

19. The system of claim 18, wherein:
the first BMS is further configured to output a charging current signal to the switch mode power supply; and
the buck component is further configured to output the charging current at a charging current level according to the charging current signal.

20. The system of claim 18, wherein:
the boosted output voltage is approximately 860V; and
the received input voltage is between approximately 600V and 810V.
